(19) United States
(12) Patent Application Publication
(10) Pub. No.: US 2024/0374364 A1
(43) Pub. Date: Nov. 14, 2024

(54) BRUSH HEAD AND ELECTRIC TOOTHBRUSH THEREOF AND BRUSH HEAD INSERT

(71) Applicant: NINGBO SEAGO ELECTRIC CO., LTD., NINGBO CITY (CN)

(72) Inventor: Yanzhong Cai, NINGBO CITY (CN)

(21) Appl. No.: 18/430,729

(22) Filed: Feb. 2, 2024

(30) Foreign Application Priority Data
May 10, 2023 (CN) 202310522651.6

(51) Int. Cl. A61C 17/22; A46B 5/00

(52) U.S. Cl. CPC A61C 17/222; A46B 5/0095

(57) ABSTRACT

The present invention discloses a brush head, an electric toothbrush thereof and a brush head insert, wherein the brush head comprises a brush head body and a brush head insert, an elastic arm and a fixed arm are provided on the brush head insert, a fixed slot is provided in the brush head body, a groove is provided on the elastic arm and the fixed arm, an elastomer is embedded in the groove, and the elastomer is in an interference fit with an inner wall of the brush head body.

### TECHNICAL FIELD

The present application pertains to the technical field of toothbrushes, and specifically pertains to a brush head, an electric toothbrush thereof and a brush head insert.

### BACKGROUND

Electric toothbrushes are common cleaning tools, and mainly comprise handles and brush heads. The toothbrush head should be changed regularly during use to ensure cleaning effect and hygienic safety of the electric toothbrush. To facilitate mounting and removal of the toothbrush head, a brush head insert is provided within the toothbrush head by which the brush head is connected with a motor shaft on the handle. The brush head insert is generally obtained by an injection molding process, and in the case of repeatedly inserting and removing the toothbrush head, it is easy to cause irreversible deformation of the brush head insert, thus leading to loose fit between parts and great noise from the toothbrush.

Chinese invention patent No. CN101902986B discloses a brush head/handle interface for an electric toothbrush, which uses a spring member to solve the problem of connection and fixation between a motor drive shaft and a brush head connecting member in the case of multiple insertions and removals. However, there are certain defects in such structural design. Tightening between the motor drive shaft and the brush head connecting member is only maintained by a tightening force of the spring member material itself. During long-term use, the spring member will age, leading to decrease in the tightening force. In addition, the spring member has problems such as inconvenient assembly, difficult production and manufacturing, and high cost.

### SUMMARY

It is an object of the present invention to provide a brush head, an electric brush thereof and a brush head insert to address the deficiencies of the prior art.

One advantage of the present invention is that a brush head body and the brush head insert fit tightly, which facilitates insertion and removal.

Another advantage of the present invention is that the brush head insert is embedded/filled with an elastomer which can extend a service life of the brush head insert and reduce noise of the toothbrush caused by loose fit between the parts due to deformation of the brush head insert.

A still further advantage of the present invention is that the elastomer can continuously provide a tightening force, making connection between a motor drive shaft and the brush head insert stabler and tighter.

A yet further advantage of the present invention is that the elastomer can compensate for the tolerance of the brush head insert due to the injection molding process and reduce noise caused by assembly gaps due to the tolerance.

As a first example of the present application, there is provided a brush head which comprises a brush head body and a brush head insert, a mounting slot is provided in the brush head body, the brush head insert is mounted in the mounting slot, an elastic arm and a fixed arm are provided on the brush head insert, a fixed slot is formed in the brush head body and is provided between the elastic arm and the fixed arm, the fixed slot is configured to snap-fit and fix a motor drive shaft, a groove is provided on both the elastic arm and the fixed arm, and an elastomer is embedded on the groove, the elastomer is arranged between the brush head insert and an inner wall of the brush head body, and the elastomer is in an interference fit with the inner wall of the brush head body.

As a second example of the present application, there is provided an electric toothbrush which is composed of the above-mentioned brush head and a toothbrush handle, a motor drive shaft is provided on the toothbrush handle, and the motor drive shaft is snap-fitted and fixed in a fixed slot of the brush head.

As a third example of the present application, there is provided a brush head insert which comprises:
an insert top end,
an elastic arm extending in a longitudinal direction and having elasticity in a radial direction;
a fixed arm arranged opposite to the elastic arm and having substantially no elasticity in the radial direction, wherein the elastic arm and the fixed arm are arranged spaced apart or arranged around each other to form a fixed slot therebetween; and
an insert bottom end, wherein at least one end of the elastic arm and the fixed arm is connected to or integrally formed with the insert top end or the insert bottom end; and
wherein both sides of a left side of the elastic arm are respectively provided with elongated holes arranged in a longitudinal direction so that the elastic arm has elasticity in the radial direction; and
a groove is provided on outer walls of the elastic arm and the fixed arm, an elastomer is embedded in the groove, and the elastomer is in an interference fit with an inner wall of a brush head body.

### BRIEF DESCRIPTION OF THE DRAWINGS

FIG. 1 shows a schematic view of a brush head composed of a brush head body 1 and a brush head insert 2 according to an embodiment of the present application;

FIG. 2 shows a side view of the brush head insert 2 of the brush head of FIG. 1;

FIG. 3 shows a perspective view of the brush head insert 2 of the brush head of FIG. 1;

FIG. 4 shows a schematic cross-sectional view of the brush head with a motor drive shaft 3 in an “uninserted” state;

FIG. 5 shows a schematic cross-sectional view of the brush head with the motor drive shaft 3 in an “inserted” state;

FIG. 6 shows a schematic top cross-sectional view of the brush head of FIG. 1, wherein the cross-section is taken along a position of a cross-shaped positioning portion 2120 at an upper end of a first boss 2122, as can be understood with particular reference to FIGS. 3 and 5; and

FIG. 7 shows a schematic bottom cross-sectional view of the brush head of FIG. 1, wherein the cross-section is taken along positions of a first fixed strip 2131 and a second fixed strip 2132, as can be understood with particular reference to FIGS. 3 and 5;

Reference numerals are as follows:
1—brush head body; 10—bristle end; 11—connection end; 12—inner wall projection; 100—mounting slot;
2—brush head insert; 20—elastic arm; 21—fixed arm; 22—free arm; 23—reinforcing arm; 200—fixed slot;
201—abutting portion; 210—groove; 211—elastomer; 212—insert top end; 213—insert bottom end; 220—free end; 2120—cross-shaped positioning portion; 2121—cross-shaped groove; 2122—first boss; 2123—second boss; 2124—limiting portion; 2130—insert base; 2131—first fixed strip; 2132—second fixed strip; 2201—snap-in portion;
3—motor drive shaft; 30—first abutting surface; and 31—first recess.

### DESCRIPTION OF THE EMBODIMENTS

In order to illustrate the above purposes, features and advantages of the present application more clearly, specific embodiments of the present application are described below in detail with reference to the accompanying drawings. In addition to the embodiments described below, the present application can also be implemented in other ways different from those described here, and those skilled in the art can make corresponding improvements, modifications and substitutions without departing from the spirit of the present application. Therefore, the present application is not limited to the specific embodiments disclosed below. The scope of protection of the present application should be subject to the appended claims.

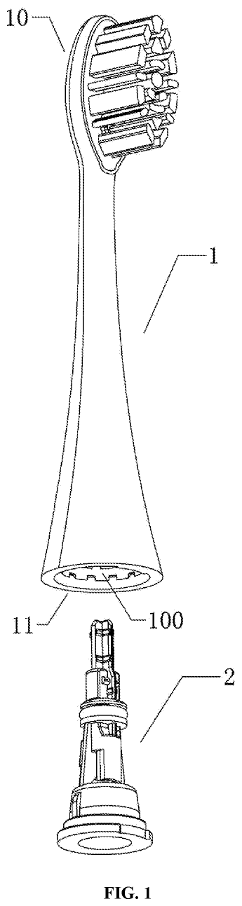

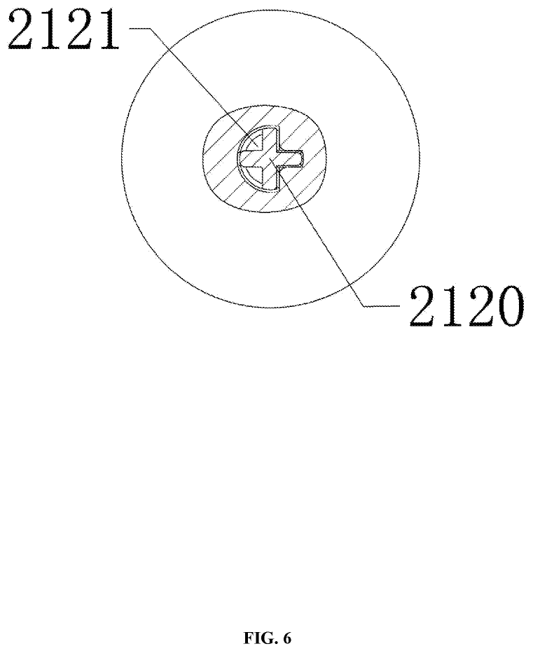

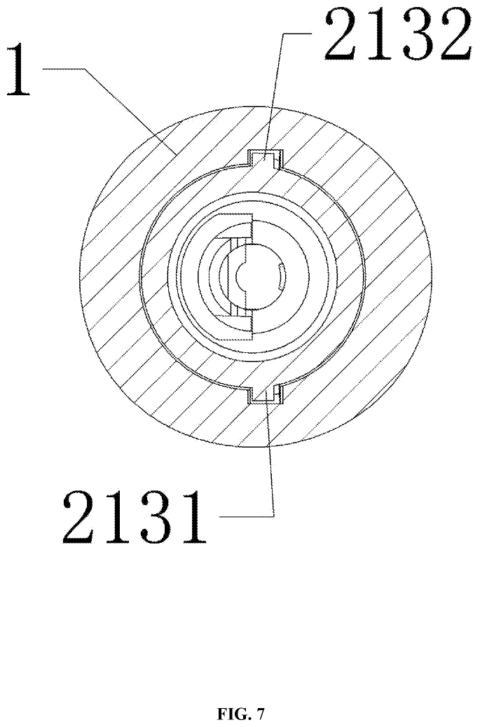

Referring to FIGS. 1-7, a brush head for an electric toothbrush comprises a brush head body 1 and a brush head insert 2, the brush head body 1 has a bristle end 10 and a connection end 11 which are arranged opposite, the bristle end 10 and the connection end 11 are located at opposite ends of the brush head body 1, a mounting slot 100 is provided in the brush head body 1, and more specifically, the mounting slot 100 is arranged at the connection end 11 of the brush head body 1, and the brush head insert 2 is mounted in the mounting slot 100.

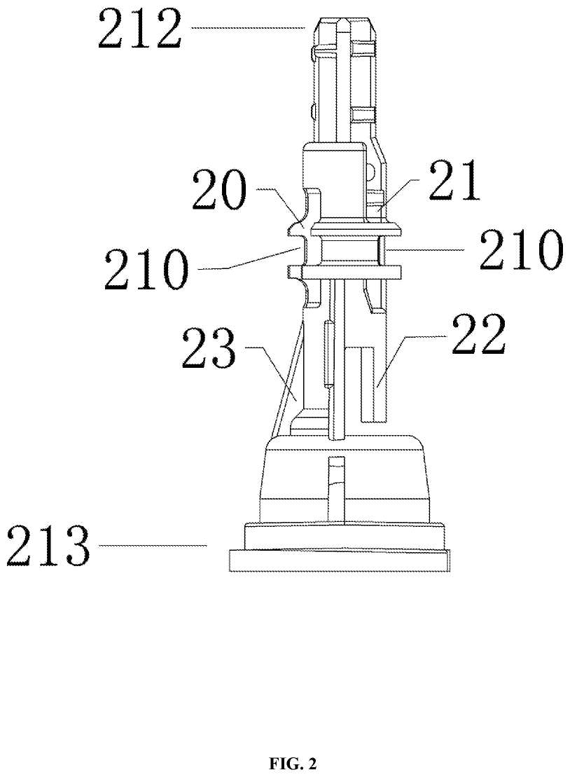

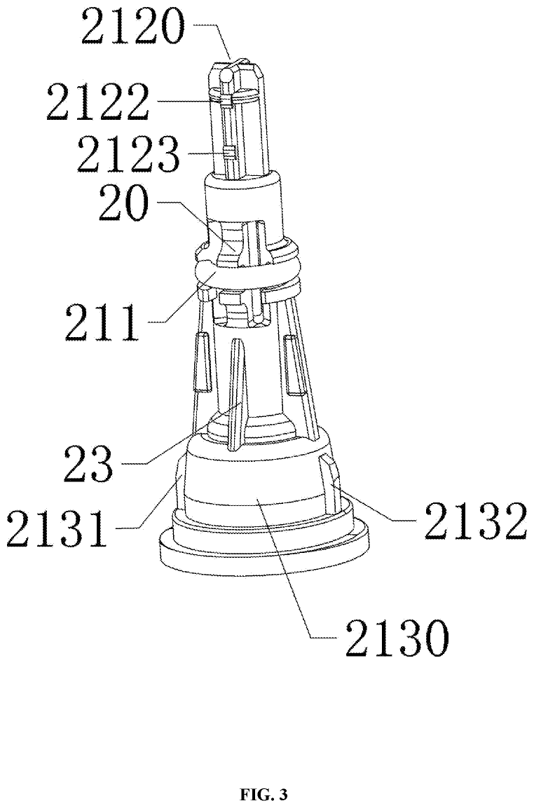

Referring to FIGS. 2-3, an elastic arm 20 and a fixed arm 21 are provided on the brush head insert 2, a fixed slot 200 is provided between the elastic arm 20 and the fixed arm 21, and the fixed slot 200 is configured to snap-fit and fix a motor drive shaft 3. A groove 210 is provided on both the elastic arm 20 and the fixed arm 21, and more specifically, the groove 210 is circumferentially recessed on an outer wall of the brush head insert 2, the groove 210 is embedded or filled with an elastomer 211, the elastomer 211 is arranged between the brush head insert 2 and an inner wall of the brush head body 1, and the elastomer 211 is in an interference fit with the inner wall of the brush head body 1. Preferably, the groove 210 is an annular groove recessed horizontally on the outer wall of the brush head insert 2, as shown in FIGS. 2-3.

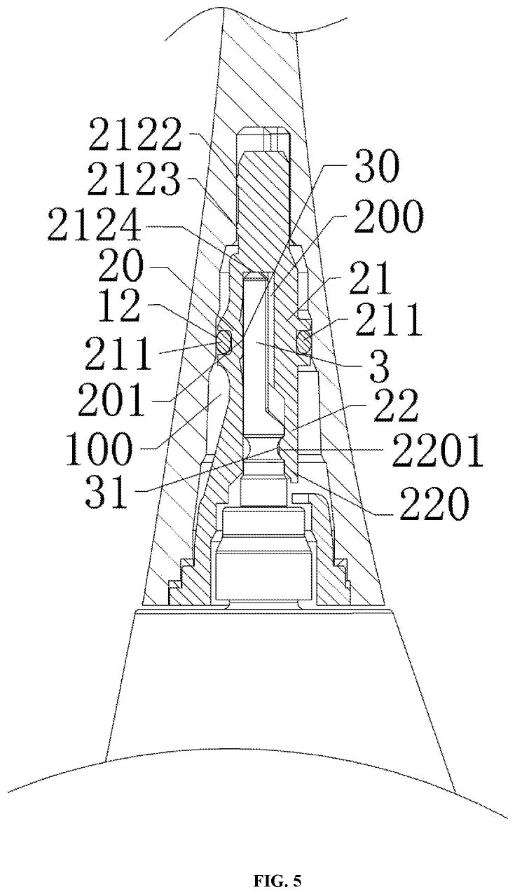

Referring to FIG. 5, when the motor drive shaft 3 is inserted into the fixed slot 200, the elastic arm 20 deforms and presses the elastomer 211 to deform, and the elastomer 211 is squeezed by the inner wall of the brush head body 1 and applies a reaction force to the elastic arm 20, and applies a reaction force to the motor drive shaft 3 by the elastic arm 20, thereby snap-fitting and fixing the motor drive shaft 3 in the fixed slot 200.

In the present example, an abutting portion 201 is further provided on the elastic arm 20, an inner wall projection 12 is provided on the inner wall of the brush head body 1, the abutting portion 201 is a projection facing into the fixed slot 200, the inner wall projection 12 is a projection facing into the mounting slot 100, the abutting portion 201 can elastically abut against the motor drive shaft 3, and the inner wall projection 12 can elastically abut against the elastomer 211.

Furthermore, since the elastomer 211 itself has a tightening function, the elastomer 211 can apply a tightening force to the elastic arm. At the same time, since the elastomer 211 and the inner wall projection 12 are in an interference fit, the inner wall projection 12 applies a corresponding reaction force to the elastomer 211 to maintain the tightening force of the elastomer 211. Double combination of the above-mentioned two structures can better maintain the tightening force of the elastomer 211, so that the elastomer 211 can continuously output the tightening force to the elastic arm 20, and the elastomer 211 is unlikely to fail. This enables the motor drive shaft 3 to maintain a tight connection with the brush head insert 2 after multiple insertions and removals, thereby avoiding abnormal noise caused by loosening between the motor drive shaft 3 and the brush head insert 2. The elastomer 211 can also mitigate irreversible deformation of the elastic arm 20 due to multiple insertions and removals, extending a service life of the brush head insert 2, while reducing noise resulting from loose assembly due to part deformation.

It will be appreciated that since the fixed slot 200 is generally sized to fit the motor drive shaft 3 on a toothbrush handle, the elastic arm 20 is squeezed when the motor drive shaft 3 is inserted into the fixed slot 200, causing elastic deformation of the elastic arm 20. The elastic arm 20 will apply a reaction force to the motor drive shaft 3 by the abutting portion 201 while undergoing the elastic deformation, thereby stably snap-fitting the motor drive shaft 3 in the fixed slot 200, achieving a stable connection between the brush head body 1 and the toothbrush handle. Also, since the motor drive shaft 3 is elastically snap-fitted into the fixed slot 200, when the brush head needs to be removed from the toothbrush handle, it is only necessary to pull out the brush head with force, which is very convenient and quick.

In other examples, the brush head insert 2 described above may also be used alone, that is, the brush head insert 2 having the structure described above may be used as a separate component rather than being incorporated into a brush head with the brush head body 1.

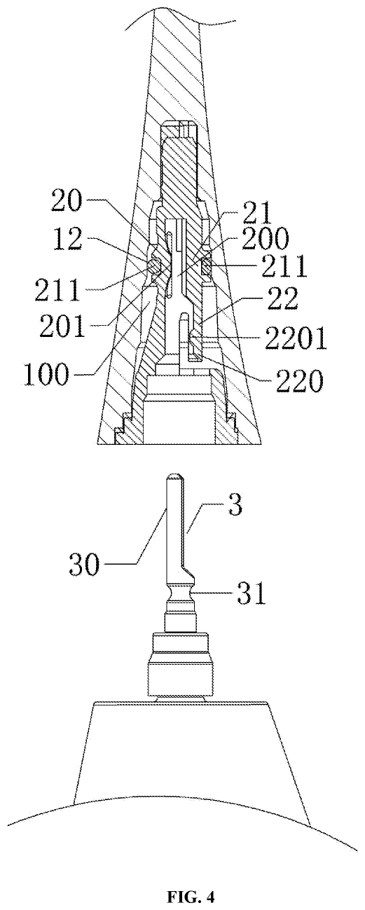

Referring to FIGS. 4-5, when the motor drive shaft 3 is not inserted into the fixed slot 200, an amount of interference between the elastomer 211 and the inner wall of the brush head body 1 is preferably 0.3-0.5 mm. The amount of interference can provide a pre-support or pre-interference effect, so that the inner wall of the brush head body 1 always outputs a pressing effect to the elastomer 211, playing a strengthening role and preventing a decrease in the tightening force of the elastomer 211.

When the motor drive shaft 3 is fully inserted into the fixed slot 200, since the abutting portion 201 has a certain thickness, the amount of interference between the elastomer 211 and the inner wall of the brush head body 1 is preferably 0.3-0.5 mm plus the thickness of the abutting portion 201. When the above-mentioned amount of interference is too large, the motor drive shaft 3 and the brush head insert 2 are prone to excessive tight fit, making it difficult to insert and remove the motor drive shaft 3, and easily damaging the brush head insert 2. When the above-mentioned amount of interference is too small, the elastomer 211 cannot play an effective supporting and tightening role for the deformation of the elastic arm 20.

The elastomer 211 in the present example is a flexible silicone ring which is made of a silicone material having characteristics such as wear resistance, high temperature resistance, being non-toxic and tasteless and good elasticity. Therefore, after multiple insertions and removals of the motor drive shaft 3, due to the good elasticity of the elastomer 211 itself and continuous application of the reaction force to the elastomer 211 by the inner wall projection 12, the elastic arm 20 can always be tightly connected with the motor drive shaft 3

Of course, the elastomer 211 can be in a variety of forms. For example, the elastomer 211 can also be an elastic material embedded in the brush head insert 2, and the elastic material can be integrally formed with the brush head insert 2, which can be specifically arranged according to actual situations, and is not specifically limited in the present application.

In the present example, the groove 210 is provided on the brush head insert 2, and the elastomer 211 is a flexible silicone ring which can be easily fitted to the groove 210, which simplifies operation and facilitates production and manufacture.

As the brush head insert 2 is typically obtained by an injection molding process, the elastomer 211 can also compensate for a manufacturing tolerance of the brush head insert 2, reducing noise caused by assembly gaps due to the tolerance.

Specifically, when the brush head needs to be changed, it is only necessary to hold the toothbrush handle and apply a force to the brush head to pull it out. During the insertion and removal process, due to a deformation limit of the elastic arm 20, the brush head and toothbrush handle can be quickly separated and connected.

Both sides of the elastic arm 20 are designed to be hollow, which facilitates deformation of the elastic arm 20 when squeezed by the motor drive shaft 3, ensuring that the motor drive shaft 3 can be easily snap-fitted into or removed from the fixed slot 200. Also in the present example, the elastic arm 20 is allowed to appropriately deform or displace in a radial direction along the brush head insert 2 to have elasticity, while the fixed arm 21 substantially presents no elasticity. Referring to FIGS. 2 and 3, in the present example, the elastic arm 20 and the fixed arm 21 are both integrally formed on the brush head insert 2, and there are hollow through holes arranged in a longitudinal direction at left and right sides of the elastic arm 20 to enable the elastic arm 20 to deform in the radial direction to have good elasticity; wherein the fixed arm 21 occupies more than half a circle on a circumference, so that the fixed arm 21 substantially has no elasticity, that is, the fixed arm is substantially incapable of being displaced or deformed in the radial direction to form the elasticity. The longitudinal direction and the radial direction are understood relative to a relative position of the brush head insert 2 shown in FIGS. 2-3, the brush head insert 2 is a cylindrical elongated component, with a length direction thereof as the longitudinal direction and a direction radiating outward from a central axis along a horizontal cross-section as the radial direction.

The brush head insert 2 comprises an insert top end 212 and an insert bottom end 213, the insert top end 212 comprises a cross-shaped positioning portion 2120, a cross-shaped groove 2121 corresponding to the cross-shaped positioning portion 2120 is provided in the mounting slot 100, the cross-shaped positioning portion 2120 is configured to quickly locate a snap-in position of the brush head insert 2 in the mounting slot 100, and when the cross-shaped positioning portion 2120 and the cross-shaped groove 2121 are arranged facing each other, the brush head insert 2 can be smoothly inserted into the mounting slot 100 for fixing. The cross-shaped positioning portion 2120 has a small cross-sectional area and a concentrated force, which further tightens the connection between the brush head insert 2 and the brush head body 1 and reduces loosening.

In the present example, upper and lower ends of the elastic arm 20 and the fixed arm 21 are integrally formed with the insert top end 212 and the insert bottom end 213 respectively, and the elastic arm 20 and the fixed arm 21 are also arranged in a circumferential direction to form the fixed slot 200 around an interior of the brush head insert 2. Of course, in other examples, the elastic arm 20 and the fixed arm 21 are arranged spaced apart and the fixed slot 200 is arranged between the elastic arm 20 and the fixed arm 21. In this case, the elastic arm 20 needs to have a displacement or deformation capability in the radial direction to be elastic, while the fixed arm 21 substantially has no elasticity. In the present example, whether the elastic arm 20 and the fixed arm 21 has elasticity mainly depends on thickness thereof in the circumferential direction, the elastic arm 20 having a thin thickness can exhibit elasticity in the radial direction, while the fixed arm 21 having a large circumferential thickness does not exhibit elasticity in the radial direction.

Referring to FIGS. 3 and 4, the insert bottom end 213 further comprises an insert base 2130, a first fixed strip 2131 and a second fixed strip 2132 are provided on both sides of the insert base 2130, the first fixed strip 2131 and the second fixed strip 2132 are in a convex strip shape, and the first fixed strip 2131 and the second fixed strip 2132 are in snap-fit with the inner wall of the brush head body 1 to prevent the brush head insert 2 from deflecting and moving. Of course, it is also possible to have a projection on an inside of the brush head body 1 and a groove on the insert base 2130, depending on practical requirements. There are at least two fixed strips arranged at intervals in a circumferential direction of the brush head body 1 for the snap-fit stability. It will be appreciated that fit between the projection and the groove greatly facilitates assembly and disassembly of brush head insert 2 on the brush head body 1.

Referring to FIG. 3, a triangular reinforcing arm 23 is also provided between the insert base 2130 and the elastic arm 20. The reinforcing arm 23 is configured to enhance stability of the brush head insert 2, so that the brush head insert 2 is less prone to deformation. A plurality of reinforcing arms 23 may be arranged according to the actual structure, and the present application does not specifically limit the number thereof.

The insert bottom end 213 and the connection end 11 of the brush head body 1 are fixed by ultrasonic welding, making the connection between the brush head body 1 and the brush head insert 2 stabler.

Referring to FIG. 4, the motor drive shaft 3 comprises a first abutting surface 30 abutting against the elastic arm 20, the first abutting surface 30 is one side of the motor drive shaft 3 in a semi-circular arc shape, and an area of the first abutting surface 30 is greater than an area of the elastic arm 20 to ensure a sufficient abutting contact area, ensure that the elastic arm 20 can tightly abut against the motor drive shaft 3, and further ensure the stability of snap-fitting the motor drive shaft 3 in the fixed slot 200.

The motor drive shaft 3 comprises a first recess 31, the brush head insert 2 further comprises a free arm 22, one end of the free arm 22 is connected with the fixed arm 21, and the other end thereof is a free end 220, the free end 220 further comprises a snap-in portion 2201, the snap-in portion 2201 is a projection facing into the fixed slot 200, and the snap-in portion 2201 is snapped into the first recess 31 on the motor drive shaft 3 to better fix and snap the motor drive shaft 3 into the fixed slot 200.

It will be appreciated that when the motor drive shaft 3 is fully inserted into the fixed slot 200, the snap-in portion 2201 is in snap-fit with the first recess 31 of the motor drive shaft 3, and a “click” sound is emitted to remind a user that the motor drive shaft 3 and the brush head are connected in place and a toothbrush can be activated for oral cleaning.

A limiting portion 2124 is provided below the cross-shaped positioning portion 2120, the limiting portion 2124 abuts against a top of the motor drive shaft 3, and the limiting portion 2124 limits a depth at which the motor drive shaft 3 is inserted into the fixed slot 200.

A first boss 2122 and a second boss 2123 which are parallel to the elastic arm 20 are provided on an outer wall of the cross-shaped positioning portion 2120, the first boss 2122 and the second boss 2123 have elasticity, and the first boss 2122 and the second boss 2123 abut against the inner wall of the brush head body 1. The above structure makes the connection of the brush head insert 2 in the mounting slot 100 stabler, thereby further reducing abnormal noise caused by loose accessories during operation of the toothbrush head.

The present invention also provides an electric toothbrush which comprises a brush head and a toothbrush handle (not shown), the toothbrush handle has a motor drive shaft 3 thereon, and the brush head is detachably connected with the toothbrush handle by the motor drive shaft 3.

In summary, with the electric toothbrush according to the present example, a brush head insert 2 is mounted in a mounting slot 100 in a brush head body 1, the brush head insert 2 is provided with an elastic arm 20 and a fixed arm 21 thereon, a fixed slot 200 is provided between the elastic arm 20 and the fixed arm 21, and the motor drive shaft 3 is inserted into the fixed slot 200 to facilitate disassembly and assembly of the brush head. The brush head insert 2 is sheathed with an elastomer 211, and the elastomer 211 is provided in interference between the brush head body 1 and an inner wall of the brush head insert 2; the elastomer 211 can mitigate irreversible deformation of the elastic arm 20 caused by multiple insertions and removals, prolong a service life of the brush head insert 2, thereby preventing loosening between the motor drive shaft 3 and the brush head insert 2 and reducing noise generated during operation of the electric toothbrush. In addition, the elastomer 211 itself has a certain tightening force, and the tightening force can act on the elastic arm 20, and since an inner wall projection 12 continuously applies a reaction force to the elastomer 211, this structure can maintain the tightening force of the elastomer 211, and prevent the tightening force of the elastomer 211 from decreasing or failing after multiple insertion and removals, so as to ensure that the motor drive shaft 3 can be stably fixed in the fixed slot.

In other examples, there is also provided an electric toothbrush body structure which comprises a toothbrush handle and a brush head insert 2, wherein the brush head insert 2 is as described above, and a motor drive shaft 3 of the toothbrush handle is mounted in a fixed slot 200 of the brush head insert 2.

What is claimed is:

1. A brush head, comprising a brush head body and a brush head insert, wherein a mounting slot is provided in the brush head body, the brush head insert is mounted in the mounting slot, an elastic arm and a fixed arm are provided on the brush head insert, a fixed slot is formed in the brush head body and is provided between the elastic arm and the fixed arm, the fixed slot is configured to snap-fit and fix a motor drive shaft, a groove is provided on both the elastic arm and the fixed arm, and an elastomer is embedded on the groove, the elastomer is arranged between the brush head insert and an inner wall of the brush head body, and the elastomer is in an interference fit with the inner wall of the brush head body.

2. The brush head according to claim 1, wherein both sides of the elastic arm are hollow, so that the elastic arm deforms when squeezed to ensure that the motor drive shaft is stably snap-fitted into the fixed slot.

3. The brush head according to claim 1, wherein an amount of interference between the elastomer and the inner wall of the brush head body is 0.3-0.5 mm; or
the groove is circumferentially recessed on an outer wall of the brush head insert, and the elastomer is a flexible silicone ring and is fitted to the groove.

4. The brush head according to claim 2, wherein an abutting portion is further provided on the elastic arm, the abutting portion is a projection facing into the fixed slot, the inner wall of the brush head body has an inner wall projection, the inner wall projection is a projection facing the groove, and the abutting portion and the inner wall projection are capable of elastically abutting against the motor drive shaft and the elastomer respectively.

5. The brush head according to claim 2, wherein the brush head insert comprises an insert top end and an insert bottom end, at least one end of the elastic arm and the fixed arm is connected to or integrally formed with the insert top end or the insert bottom end, and both sides of a left side of the elastic arm are respectively provided with elongated holes arranged in a longitudinal direction so that both sides of the elastic arm form a hollow design.

6. The brush head according to claim 5, wherein the insert top end comprises a cross-shaped positioning portion, and an inside of the mounting slot has a cross-shaped groove corresponding to the cross-shaped positioning portion for quickly locating a mounting position of the brush head insert in the mounting slot;
a first boss and a second boss are further provided on an outer wall of the cross-shaped positioning portion, and the first boss and the second boss have elasticity; and
the insert bottom end further comprises an insert base, and both sides of the insert base are respectively provided with a first fixed strip and a second fixed strip arranged in a longitudinal direction.

7. An electric toothbrush, comprising the brush head according to claim 1 and a toothbrush handle, wherein a motor drive shaft is provided on the toothbrush handle, and the motor drive shaft is snap-fitted and fixed in the fixed slot of the brush head.

8. The electric toothbrush according to claim 7, wherein the motor drive shaft further comprises a first recess, the brush head insert further comprises a free arm, one end of the free arm is connected with the fixed arm, the other end thereof is a free end, the free end further comprises a snap-in portion, the snap-in portion is a projection facing into the fixed slot, and the snap-in portion is snapped into the first recess on the motor drive shaft; or
the motor drive shaft comprises a first abutting surface abutting against the elastic arm, and the first abutting surface has an area greater than an area of the elastic arm.

9. A brush head insert, comprising:
an insert top end,
an elastic arm extending in a longitudinal direction and having elasticity in a radial direction;
a fixed arm arranged opposite to the elastic arm and having substantially no elasticity in the radial direction, wherein the elastic arm and the fixed arm are arranged spaced apart or arranged around each other to form a fixed slot therebetween; and
an insert bottom end, wherein at least one end of the elastic arm and the fixed arm is connected to or integrally formed with the insert top end or the insert bottom end; and
wherein both sides of a left side of the elastic arm are respectively provided with elongated holes arranged in a longitudinal direction so that the elastic arm has elasticity in the radial direction;
a groove is provided on outer walls of the elastic arm and the fixed arm, an elastomer is embedded in the groove, and the elastomer is in an interference fit with an inner wall of a brush head body;
an amount of interference between the elastomer and the inner wall of the brush head body is 0.3-0.5 mm; and
the elastomer is a flexible silicone ring and fitted to the groove or the elastomer is made of an elastic material embedded in the groove.

10. The brush head insert according to claim 9, wherein an abutting portion is further provided on the elastic arm, and the abutting portion is a projection facing into the fixed slot for abutting against a motor drive shaft; and
one end of the fixed arm is connected with or integrally formed with the insert top end, and the other end thereof is formed as a free end, a snap-in portion is provided on the free end, and the snap-in portion is a projection facing into the fixed slot; and after assembly, the motor drive shaft abuts against at one side thereof a face where the abutting portion is located and is limited by the snap-in portion in the longitudinal direction.
